(19) United States
(12) Patent Application Publication
(10) Pub. No.: US 2026/0291955 A1
(43) Pub. Date: Sep. 24, 2026

(54) CREDIBILITY AND RELIABILITY-BASED CYBER THREAT ATTRIBUTION

(71) Applicant: Palo Alto Networks, Inc., Santa Clara, CA (US)

(72) Inventors: Kyle Stevan Wilhoit, Festus, MO (US); David Fuertes, Madrid (ES); Robert Louis Falcone, Weymouth, MA (US)

(21) Appl. No.: 19/085,640

(22) Filed: Mar. 20, 2025

(51) Int. Cl. H04L 9/40

(52) U.S. Cl. CPC H04L 63/1416; H04L 63/1425

(57) ABSTRACT

A threat attribution module provides an analysis framework to a cyber threat analyst for escalating activity clusters to temporary threat groups and escalating temporary threat groups to formal threat actors. The threat attribution module relies on event/observable data including victim patterns, indicators of compromise, and tactics, techniques, and procedures to escalate attribution levels. Escalation of attribution levels is based on both the event/observable data, diamond model vertices covered by an attribution, and confidence of the attribution as computed by an aggregate of reliability scores for data sources and credibility scores for types of the event/observable data.

### BACKGROUND

The disclosure generally relates to data processing (e.g., CPC subclass G06F) and to computing arrangements based on specific computational models (e.g., CPC subclass G06N).

The diamond model is a framework for understanding cyber threats for the eventual purpose of threat attribution. The diamond model consists of a diamond graph having four vertices representing different aspects/categories of malware analysis-“infrastructure”, “capability”, “adversary”, and “victim”. Cybersecurity events and observables can be linked to one or more of these vertices, with some events corresponding to edges between the vertices. The diamond model can be applied to causal sequences of events by tracking traversal through vertices in the diamond model via the events/observables.

### BRIEF DESCRIPTION OF THE DRAWINGS

Embodiments of the disclosure may be better understood by referencing the accompanying drawings.

FIG. 1 is a diagram of an example system for implementing a threat attribution module to escalate events to activity clusters, activity clusters to temporary threat groups, and temporary threat groups to formal threat actors.

FIG. 2 is a diagram of an example attribution table for determining confidence of attribution for an activity cluster, a temporary threat group, and/or a formal threat actor.

FIG. 3 is a flowchart of example operations for detecting/validating activity clusters in cybersecurity events/observables.

FIG. 4 is a flowchart of example operations for promoting/escalating an activity cluster to a temporary threat group.

FIG. 5 is a flowchart of example operations for promoting/escalating a temporary threat group to a formal threat actor.

FIG. 6 is a flowchart of example operations for determining attribution confidence with attribution tables.

FIG. 7 depicts an example computer system with a threat attribution module.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Activity clusters are commonly tracked according to victim patterns, attack behaviors, indicators of compromise (IoCs), and tactics, techniques, and procedures (TTPs) through data such as event logs, network artifacts, signatures, etc. that are loosely associated and may or may not be attributed to common threat actors. By contrast with malicious campaigns that include documented coordinated activities with known objectives and are attributed to specific threat actors, many activity clusters may not have sufficient structure to be accurately attributed, or even be definitively associated with a same threat actor. Moreover, although existing tools such as the diamond model provide analysts with perspectives of activity clusters that aid with attribution, there is no definitive criteria or methodology for how to attribute activity clusters to varying levels of threat attributions having increasing confidence in those attributions.

A threat attribution module disclosed herein provides a score-based and criteria-based methodology that precisely guides analysts in escalating collections of events/observables into activity clusters, escalating activity clusters into temporary threat groups, and confirming temporary threat groups as corresponding to formal threat actors. Each stage of threat attribution combines the events/observables, including IoCs, TTPs, and victim analysis with perspectives of the diamond model (e.g., by requiring multiple perspectives be present in the events/observables) and reliability and credibility of data and its sources according to the Admiralty system. Escalation at each stage has increasingly stricter requirements for the types and temporal frequency of events/observables, confidence of attributions/Admiralty system thresholds, as well as the presence of multiple perspectives in the diamond model. Guidance provided by the threat attribution module enables cyber threat analysts to easily escalate activity clusters to temporary threat groups and temporary threat groups to formal threat actors in a framework that maintains consistency across attributions, reducing the reliance on subjective analyst evaluations and instead providing a codified, quantitative attribution approach.

### Example Illustrations

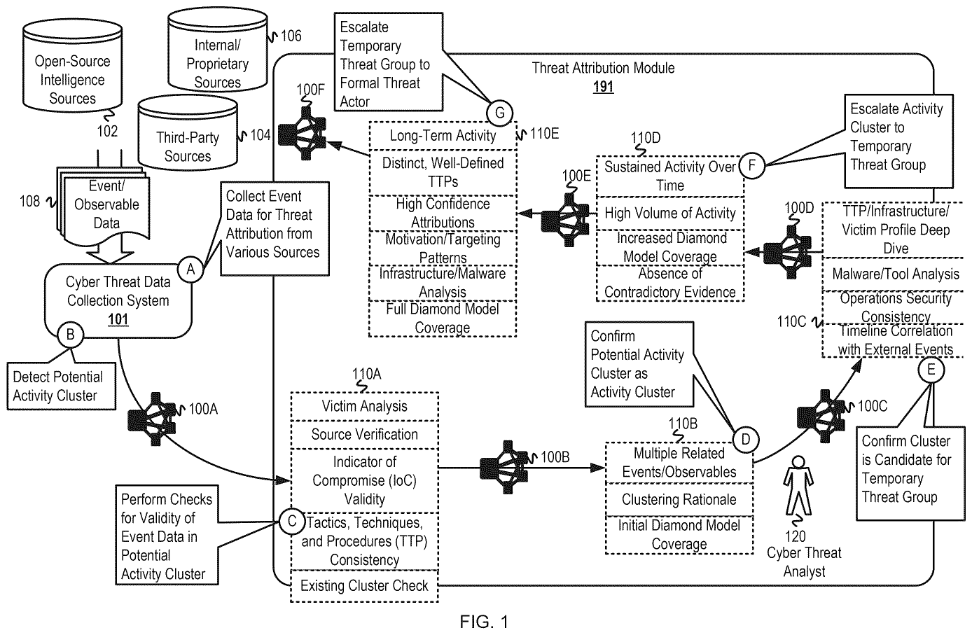

FIG. 1 is a diagram of an example system for implementing a threat attribution module to escalate events to activity clusters, activity clusters to temporary threat groups, and temporary threat groups to formal threat actors. A cyber threat data collection system 101 receives event/observable data 108 from open-source intelligence (OSINT) sources 102, internal/proprietary sources 106, and third-party sources 104. The event/observable data 108 is analyzed to detect potential activity clusters, and these potential activity clusters are fed into a threat attribution module 191.

FIG. 1 is annotated with a series of letters A-G representing stages of operations, each stage corresponding to one or more operations. The threat attribution module 191 performs or codifies the stages C-G of operations for threat analysis-escalating potential activity clusters to activity clusters at stages C and D, escalating activity clusters to temporary threat groups at stages E and F, and escalating temporary threat groups to formal threat actors at stage G. Although these stages are ordered for this example, the stages illustrate one example to aid in understanding this disclosure and should not be used to limit the claims. Subject matter falling within the scope of the claims can vary from what is illustrated. FIG. 1 depicts a cyber threat analyst 120 interacting with the threat attribution module 191 at stages C-G.

At stage A, the cyber threat data collection system 101 collects the event/observable data 108 for threat attributions from the data sources 102, 104, and 106. The OSINT sources 102 can comprise public research sources, government sources, etc. The internal/proprietary sources 106 can comprise internal logs for an organization associated with the threat attribution module 191 and can include internal telemetry data. The third-party sources 104 can be known/trusted sources such as intelligence from other organizations, industry-wide trusted intelligence, etc. The event/observable data 108 includes metadata (e.g., descriptions, context, etc.) and/or logs associated with IoCs, TTPs, victims, etc. Each source from the data sources has a reliability codified by the following qualitative descriptions from the Admiralty System that inform the cyber threat analyst 120:

| Score | Keywords | Description |
|---|---|---|
| A | Reliable | No doubt about the source's authenticity, |
| | | trustworthiness, or competency. History |
| | | of complete reliability. |
| B | Usually reliable | Minor doubts. History of mostly valid |
| | | information. |
| C | Fairly reliable | Doubts. Provided valid information in |
| | | the past. |
| D | Not usually reliable | Significant doubts. Provided valid |
| | | information in the past. |
| E | Unreliable | Lacks authenticity, trustworthiness, and |
| | | competency. History of invalid |
| | | information. |
| F | Reliability unknown | Insufficient information to evaluate |
| | | reliability. May or may not be reliable. |

As examples of default scores, internal and trusted third-party data sources can have reliability “A”, trusted public research can have reliability “B”, public research can have reliability “C”, untrusted public research can have reliability “D”, and other or underground data sources can have reliability “F”. The cyber threat analyst 120 can adjust reliability of data sources on a case-by-case basis based on domain-level knowledge of reliability of data sources.

At stage B, the cyber threat data collection system 101 detects a potential activity cluster 100A. For instance, the cyber threat analyst 120 (or other analyst/administrator) can track aspects/perspectives/categories of the diamond model, such as infrastructure (Internet Protocol (IP) addresses, domains, uniform resource locators (URLs), etc.), capabilities (malware, tools, TTPs), and victims (organizations, industries, regions) for commonalities across the event/observable data 108, and detect a potential activity cluster when a sufficient number of common events/observables (e.g., multiple observables across multiple vertices of the diamond model) have been detected. An example of events detected as a potential activity cluster comprises the following events:
Event 1: A phishing email targeting a financial institution contains a malicious attachment with a specific SHA-256 hash.
Event 2: A different financial institution reports a malware infection with the same SHA-256 hash.
Event 3: OSINT reveals a blog post linking this SHA-256 hash to a suspected phishing campaign.

At stage C, the cyber threat analyst 120 receives the potential activity cluster 100A and performs a set of analyses 110A according to the threat attribution module 191 to check for validity of the event data in the potential activity cluster 100A. The cyber threat analyst 120 then designates the potential activity cluster 100A as a validated activity cluster 100B. The set of analyses 110A includes victim analysis, source verification, IoC validity, TTP consistence, and an existing cluster check. Victim analysis comprises analyzing targeting patterns such as common characteristics across victims (e.g., industry, geography, organizational size), and determining whether these targeting patterns align with a suspected actor's known objectives. The victim analysis can additionally comprise determining whether victim selection appears deliberately misleading to implicate other threat actors, which would suggest that the potential activity cluster is not an activity cluster but instead a misdirection. Source verification comprises assessing reliability of the information sources, for instance to determine that there are multiple sources above a “C” score or at least one source with an “A” score. IoC validity comprises determining whether IoCs include contextual information, are unique or rare, and/or are volatile. IoCs without context (e.g., file hashes without additional information), common IoCs (e.g., publicly available exploits or generic infrastructure), and highly volatile IoCs (e.g., IP addresses and domain names) are less valuable for determining activity clusters. The existing cluster check comprises determining whether the potential activity cluster 100A corresponds to an existing cluster (e.g., by evaluating infrastructure/victim metadata against known activity clusters), and, if so, merging the potential activity cluster 100A with the existing cluster. The threat attribution module 191 can specify that certain of the set of analyses 110A have quantitative criteria be satisfied (e.g., for source verification), whereas others have qualitative criteria that rely on judgments by the cyber threat analyst 120. All of the subsequent sets of analyses 110B, 110C, 110D, and 110E for the remaining stages can also include both quantitative and qualitative criteria for evaluation by the cyber threat analyst 120 when determining whether to perform corresponding escalations.

At stage D, the cyber threat analyst 120 performs a set of analyses 110B according to the threat attribution module 191 to confirm that the validated activity cluster 100B is an activity cluster 100C. The set of analyses 110B comprises determining that the validated activity cluster 100B comprises multiple related event/observables such as shared IoCs (shared IP addresses, domain name, files hashes, etc.), TTPs targeting a same organization or industry or using the same malware family/exploitation techniques/command-and-control infrastructure, events occurring within a close timeframe, etc. The set of analyses 110B also include a rationale for the clustering, i.e., a natural language explanation of the shared characteristics of the events/observables that led to the cluster grouping—this is important when other analysts besides the cyber threat analyst 120 analyze the activity cluster 100C. Finally, the set of analyses 110B can optionally comprise a determination that multiple (>=2) vertices (i.e., perspectives, categories, etc.) of the diamond model are covered by the validated activity cluster 100B. The above example including events 1-3 would successfully be grouped into an activity cluster due to having multiple related events (phishing and malware infection) with overlapping IoCs (the SHA-256 hash) and potential victim overlap (financial institutions), with additional context provided by OSINT.

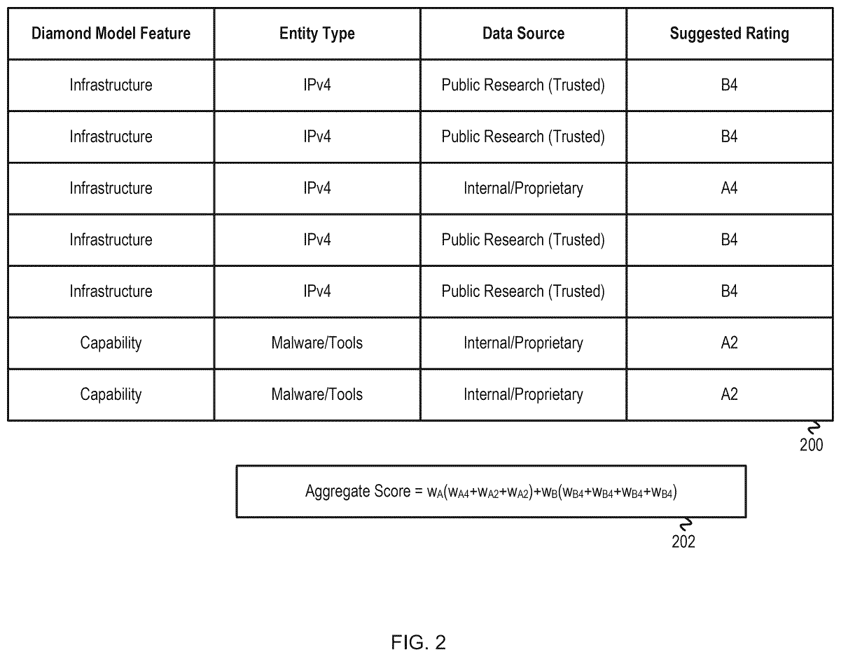

Factors that may be used later in the threat attribution analysis for escalating activity clusters to temporary threat groups and formal threat actors that are not necessary when determining activity clusters include high-confidence attributions, complete attack lifecycle mapping, and attribution table scoring. This is because an activity cluster represents a grouping of related activities that may not be associated with known actors and/or the associated actors may not be known. An example of determining attribution confidence using attribution table scoring for reliability of data sources and credibility of data types is provided in FIG. 2.

At stage E, the cyber threat analyst 120 confirms that the activity cluster 100C is a candidate 100D for being escalated to a temporary threat group with a set of analyses 110C of the threat attribution module 191. As part of the set of analyses 110C, the cyber threat analyst 120 performs a deep dive (i.e. a thorough analysis) into TTPs, infrastructure, and victim profile. The TTP deep dive comprises determining whether TTPs have granular, non-superficial overlaps within the activity cluster 100C such as associated artifacts, tools, commands, and configurations, and whether TTPs evolve consistently over time. The infrastructure deep dive comprises investigating shared hosting providers, registration patterns, etc. and potentially pivoting on infrastructure entities during the analysis to uncover additional related activities. The infrastructure deep dive can also analyze WHOIS records and/or passive Domain Name System (DNS) records for suspicious domains, patterns in registrant information or nameservers, etc. The victim profile deep dive includes analyzing organizational characteristics, technologies, and/or targeted data that link victims as well as analyzing motives for targeting to determine whether they align with an objective (e.g., espionage, financial gain, disruption, etc.).

The set of analyses 110C additionally comprise analyzing malware/tools, analyzing operations security consistency, and analyzing timeline correlation with external events. The malware/tools analysis comprises analyzing code similarities by structure/functionality/unique characteristics, code reuse, shared libraries, signs of common developers/codebases, and tool configurations such as unique configurations, custom modules, specific settings, etc. that are strong indicators of a single actor. The operations security (OPSEC) analysis comprises analyzing OPSEC practices to determine whether they make consistent mistakes or exhibit unique patterns to attempt to remain anonymous. This analysis can comprise retaining OPSEC fingerprints for subsequent attribution. The timeline correlation with external event analysis comprises correlating events in a timeline where the activity cluster 100C was observed with external events including geopolitical developments or industry-specific conferences. These external events can be tracked through the infrastructure of the activity cluster 100C. The cyber threat analyst 120 carefully analyzes each of the set of analyses 110C to determine whether the activity cluster 100C qualifies as a candidate for a temporary threat group. The cyber threat analyst 120 additionally documents a reasoning according to the set of analyses 110C for the confirmation.

At stage F, the cyber threat analyst 120 escalates the candidate 100D to a temporary threat group 100E by performing a set of analyses 110D of the threat attribution module 191. The set of analyses 110D includes analysis of sustained activity over time, high volume of activity, increased diamond model coverage, and absence of contradictory evidence. The analysis for sustained activity over time can comprise that activity of the activity cluster 100C has been observed over a specified time period (e.g., six months), although this requirement can be lessened if there is an high amount of data recorded for the activity cluster (e.g., after a major incident that prompted extensive forensic analysis and threat intelligence gathering) and the high amount of data provides additional, comprehensive insight into TTPs, infrastructures, motivations, etc. Conversely, this period of time can be extended if data for the candidate 100D is scarce. The lengthening of shortening of the time period is subject to the discretion of the cyber threat analyst 120.

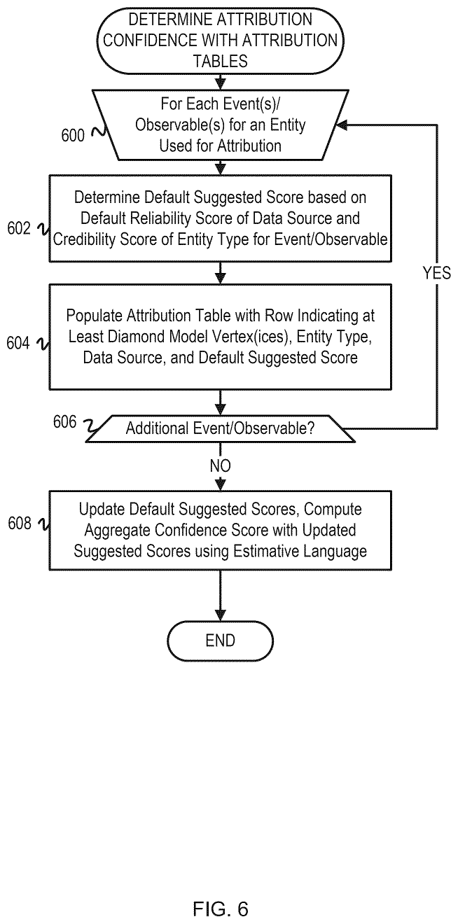

The high volume of activity analysis can be based on internal telemetry (e.g., event/observable data from internal/proprietary data sources), for instance by requiring that at least four incidents be recorded in internal telemetry during the aforementioned period of time that have moderate to high confidence of being attributed to the candidate 100D. Calculating confidence scores for attribution is described in reference to FIGS. 2 and 6. The diamond model coverage analysis can comprise that the activity should be exhibited across at least three vertices of the diamond model, and can additionally require consistent TTPs and infrastructure, unique infrastructure configurations (e.g., a non-standard setup of a web server used for command and control communication), and custom infrastructure tools (e.g., a proprietary tool for generating domain names or managing a botnet). The absence of contradictory evidence analysis comprises determining that there is no significant evidence that contradicts the hypothesis that the candidate 100D corresponds to a single actor. Contradictory evidence can comprise that TTPs or victim targeting change suddenly/drastically, and can trigger further investigation prior to escalation to a temporary threat group.

At stage G, the cyber threat analyst 120 escalates the temporary threat group 100E to a formal threat actor 100F using a set of analyses 110E of the threat attribution module 191. The set of analyses 110E include analyses of long-term activity, distinct, well-defined TTPs, high confidence attributions, motivation/targeting patterns, infrastructure/malware analysis, and full diamond model coverage. The long-term activity analysis comprises determining whether activity for the temporary threat group 100E has been observed for at least a longer time period (e.g., a year), although this analysis may be omitted if the temporary threat group 100E is a pre-existing named group, i.e., threat actors that have been previously named/defined and tracked by cybersecurity groups (sometimes publicly), either internally or by a third party. The distinct, well-defined TTPs analysis comprises determining whether the TTPs of the temporary threat group 100E are differentiated from other known actors, for instance based on unique malware tools, specific exploit techniques, specific attack lifecycles, etc. The high confidence attributions analysis comprises computing a confidence level in an overall attribution table (e.g., as described in FIGS. 2 and 6) for the temporary threat group 100E across multiple reliable data sources such as internal telemetry, trusted partners, corroborated OSINT, etc. and determining whether the confidence level is high. The motivation/targeting patterns analysis comprises developing a well-defined understanding of objectives (e.g., espionage, financial gain, disruption) and expected targets (e.g., industries, geographies, organizations, etc.) for the temporary threat group 100E. The infrastructure/malware analysis comprises demonstrating consistent use of specific infrastructure entities (e.g., IP addresses, domains, servers) over the longer time period, identification of unique code characteristics, shared codebases, links to other known malware families, etc. Finally, the full diamond model coverage comprises determining that all four vertices of the diamond model are covered by the temporary threat group 100E over the longer time period.

Unlike previous escalations, the escalation at stage F should be accompanied by estimative language for confidence levels (as documented by the cyber threat analyst 120) to provide insight, for instance using the following estimative language defined by the MISP project:
Low Confidence—Uncorroborated information from good or marginal sources. Many assumptions. Mostly weak logical inferences, minimal methods application. Glaring intelligence gaps exist. Terms or expressions used: ‘Possible’, ‘Could, may, might’, ‘Cannot judge, unclear.’
Moderate Confidence—Partially corroborated information from good sources. Several assumptions. Mix of strong and weak inferences and methods. Minimum intelligence gaps exist. Terms or expressions used: ‘Likely, unlikely’, ‘Probable, improbable’ ‘Anticipate, appear’.
High Confidence—Well-corroborated information from proven sources. Minimal assumptions. Strong logical inferences and methods. No or minor intelligence gaps exist. Terms or expressions used: ‘Will, will not’, ‘Almost certainly, remote’, ‘Highly likely, highly unlikely’, ‘Expect, assert, affirm’.

The above language should also be used by the cyber threat analyst 120 when combining reliability of the data sources 102, 104, 106 with credibility of the data therein (i.e., data in the event/observable data 108) for determining overall confidence of the temporary threat group 100E with an attribution table.

Each of the escalations according to the foregoing stages should be thoroughly documented by the cyber threat analyst 120 for use by other analysts and subsequent evaluation of clusters/threat groups/threat actors for escalation, de-escalation, merging, removal, etc. The documentation includes natural language descriptions of both qualitative and quantitative evaluations performed at each stage and further includes descriptions IoCs, TTPs, victim information, and OSINT reports. Hypothesis for motivations and attributions are constantly evolving and rely on documenting this data to reduce attribution bias that may be introduced.

FIG. 2 is a diagram of an example attribution table for determining confidence of attribution for an activity cluster, a temporary threat group, and/or a formal threat actor. FIG. 2 comprises the following example attribution table 200:

| | | Source of | |
|---|---|---|---|
| Diamond Model | Entity Type | Attribution | Suggested Score |
| Infrastructure | IPv4 | Public Research | B4 |
| | | (Trusted) | |
| Infrastructure | IPv4 | Public Research | B4 |
| | | (Trusted) | |
| Infrastructure | IPv4 | Internal | A4 |
| Infrastructure | IPv4 | Public Research | B4 |
| | | (Trusted) | |
| Infrastructure | IPv4 | Public Research | B4 |
| | | (Trusted) | |
| Capability | Malware/Tools | Internal | A2 |
| Capability | Malware/Tools | Internal | A2 |

The above example omits the explicit values for each entity, although these values are included when presented to cyber threat analysts The “suggested score” column in the example attribution table 200 indicates default reliability scores (indicated as letters according to the foregoing table) for sources of attribution and credibility scores of entity types according to the below table corresponding to the Admiralty system:

| Score | Keywords | Description |
|---|---|---|
| 1 | Confirmed | Confirmed by other independent sources; |
| | | logical in itself; Consistent with other |
| | | information on the subject |
| 2 | Probably true | Not confirmed; logical in itself; consistent |
| | | with other information on the subject |
| 3 | Possibly true | Not confirmed; reasonably logical in |
| | | itself; agrees with some other information |
| | | on the subject |
| 4 | Doubtfully True | Not confirmed; possible but not logical; |
| | | no other information on the subject |
| 5 | Improbable | Not confirmed; not logical in itself; |
| | | contradicted by other information on the |
| | | subject |
| 6 | Difficult to say | No basis exists for evaluating the validity |
| | | of the information |

Example default credibility scores for entities include 4 for IPV4 addresses, 3 for domains, 5 for “other” entities, 3 for URLs, 2 for transport layer security (TLS) fingerprints, 2 for JARM fingerprint hashes, 4 for certificate fields, 2 for certificate unique SHA-1 fingerprints, 4 for certificate unique subject fields, 2 for Secure Shell (SSH) host keys, 4 for registrant information, 3 for registration timeframes, 2 for malware/tools, 5 for public tools, 3 for unknown vulnerabilities, 5 for known vulnerabilities, 5 for organizations, 6 for industries/regions, 4 for assets, 2 for unique malware artifacts, 3 for (non-unique) malware artifacts, 2 for unique user agents, 3 for unique email sender addresses, 5 for unique file extensions, 4 for online personas/aliases, 5 for general unique command artifacts, 4 for unique command artifacts that are unusual flags or parameters, 2 for highly specific and/or rarely seen unique command artifacts, 6 for common application programing interface (API) calls, 4 for less common API calls with unusual parameters, and 2 for highly specific and/or rarely seen API calls, and for TTPs-2 for spear phishing attachments, 5 for public-facing application exploits, 5 for valid accounts, 4 for external remote services, 4 for unique command-line interfaces, 3 for scheduled tasks/jobs, 4 for software deployment tools, 4 for registry run keys/startup folders, 3 for account manipulation, 3 for exploitation for privilege escalation, 5 for valid accounts, 4 for impair defenses, 4 for masquerading, 3 for obfuscated files or information, 5 for brute force, 3 for credentials in files, 5 for system information discovery, 4 for network service scanning, 4 for remote services, 3 for lateral tool transfer, 4 for local system data, 4 for an application layer protocol, 4 for a unique command and scripting interpreter, 4 for data transfer size limits, 3 for exfiltration over an alternative protocol, and 2 for data destruction.

An aggregate score 202 for the example attribution table is the weighted product/sum of predefined weights w_{A} (w_{A4}+w_{A2}+w_{A2})+w_{B} (w_{B4}+w_{B4}+w_{B4}+w_{B4}). More generally, the aggregate score 202 (i.e., the “suggested score” presented to an analyst in the attribution table) can be computed as:

(<Reliability Weight A>*(<A Credibility Weight 1>+<A Credibility Weight 2>+<A Credibility Weight n> . . . ))+(<Reliability Weight B>*(<B Credibility Weight 1>+<B Credibility Weight 2>+<B Credibility Weight n> . . . ))+(<Reliability Weight C>*(<C Credibility Weight 1>+<C Credibility Weight 2>+<C Credibility Weight n> . . . ))+(<Reliability Weight D>*(<D Credibility Weight 1>+<D Credibility Weight 2>+<D Credibility Weight n> . . . ))+(<Reliability Weight E>*(<E Credibility Weight 1>+<E Credibility Weight 2>+<E Credibility Weight n> . . . ))+(<Reliability Weight F>*(<F Credibility Weight 1>+<F Credibility Weight 2>+<F Credibility Weight n> . . . ))

Note that in the above formula, “<Reliability Weight A>” refers to a static reliability weight for all “A” rated data sources, whereas “<A Credibility Weight i>” refers to a credibility weight for the ith entity from an A rated data source that can have any credibility rating from 1-6. There are upper and lower thresholds indicating “low”, “medium” and “high” confidence attributions based on the resulting aggregate score. The weights are chosen by a domain-level expert and the thresholds are tuned according to the weights. The upper and lower thresholds for each of these confidence levels depend on the credibility/reliability weights being used for computing aggregate scores.

As noted in the foregoing, analysts may modify credibility scores and/or reliability scores based on domain-level knowledge, including these example default scores. Any modifications must be accompanied by thorough documentation providing specific reasoning for the modifications.

When generating an attribution table, each row is determined according to predefined entity types when analyzing events/observables related to cyber threats. Entities corresponding to predefined types can be identified by cyber threat analysts or using automated processes (e.g., regex expressions for identifying IP addresses, automated collection of IoCs/TTP from cybersecurity feeds, etc.).

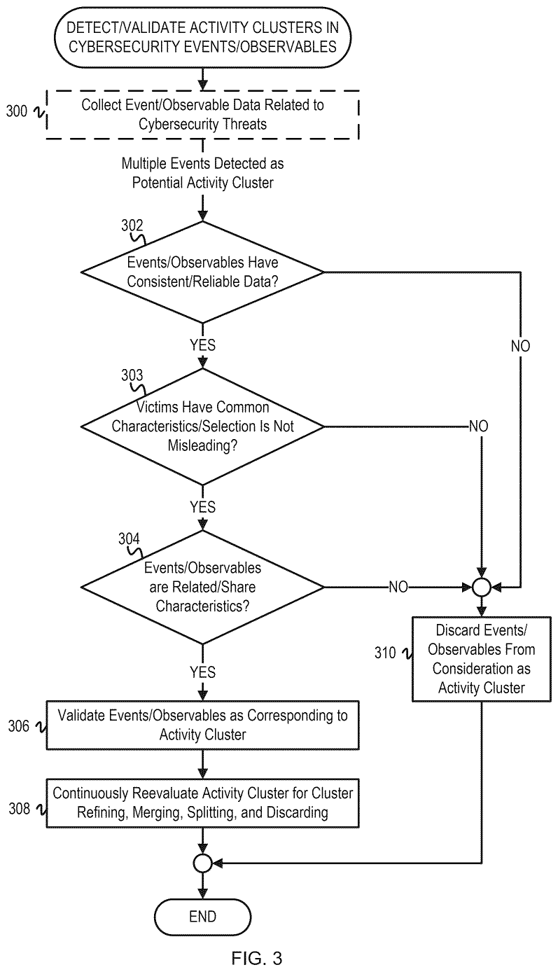

FIGS. 3-6 are flowcharts of example operations for promoting/escalating event/observable data to activity clusters, temporary threat groups, and formal threat actors at least partly using attribution tables. The example operations are described with reference to a threat attribution module and a cyber threat data collection system for consistency with the earlier figures and/or ease of understanding. Operations are described as being performed by the threat attribution module rather than a cyber threat analyst performing actions for threat attribution enabled by the threat attribution module for brevity. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary. Many of the example operations throughout the flowcharts are described in brevity due to overlap with corresponding operations described in reference to FIGS. 1-2.

FIG. 3 is a flowchart of example operations for detecting/validating activity clusters in cybersecurity events/observables. At block 300, the cyber threat data collection system collects event/observable data related to cybersecurity threats. The cyber threat data collection system collects event/observable data across data sources of varying reliability such as internal data, trusted third-parties, OSINT sources, Internet feeds, etc. The operations at block 300 are depicted with a dashed outline to indicate that collection of event/observable data is ongoing independently of the remaining operations in FIG. 3, and the subsequent operations are triggered by detecting multiple events as a potential activity cluster. Detection of events corresponding to potential activity clusters can be performed by analysts and/or automated processes for identifying common entity types across events/observables (e.g., IoCs, TTPs, etc.).

At block 302, the threat attribution module determines whether the events/observables have consistent/reliable data. For instance, the threat attribution module can determine whether there are multiple, corroborated, reliable sources of the event/observable data, whether IoCs have context, are unique, and are not volatile, whether TTPs have established patterns/internal consistency, etc. If the threat attribution module determines that the events/observables have consistent/reliable data, operational flow proceeds at block 303. Otherwise, operational flow proceeds at block 310.

At block 303, the threat attribution module determines whether victims corresponding to the activity cluster have common characteristics and that the selection of victims is not purposely misleading. The threat attribution module determines whether victims have common characteristics such as industry, geography, and organization size, and determines whether patterns for the victim align with known motives/objectives. Additionally, threat actors may attempt to intentionally mislead threat analysts by adding false flag victims, so the threat attribution module determines whether victims do not have the appearance of being purposely misleading.

At block 304, the threat attribution module determines whether the events/observables are related/share characteristics. For instance, the threat attribution module can determine whether there are multiple related events/observables according to shared characteristics such as overlapping IoCs, similar TTPs temporal proximity, etc., whether the events/observables cover at least two of the diamond model vertices, etc. If the threat attribution module determines that the events/observables are related/share characteristics, operational flow proceeds to block 306. Otherwise, operational flow proceeds to block 310.

At block 306, the threat attribution module validates the events/observables as corresponding to an activity cluster. The threat attribution module store indications of the event/observable data in association with a placeholder identifier of the activity cluster in a database of activity clusters.

At block 308, the threat attribution module continuously reevaluates the activity cluster for cluster refining, merging, splitting, and discarding. The threat attribution module can continue to associate collected event/observable data with activity clusters in the aforementioned database. Clusters can be merged as event/observable data is added that make the clusters more similar, can be discarded as event/observable data dries up for those clusters, can be refined/split as data is removed from activity clusters for being outdated, etc. Each cluster update is cataloged by a threat analyst with a reasoning for the corresponding update operations. The operational flow in FIG. 3 terminates.

At block 310, the threat attribution module discards the events/observables from consideration as an activity cluster. Data for the events/observables can nonetheless be maintained in a database for future attribution.

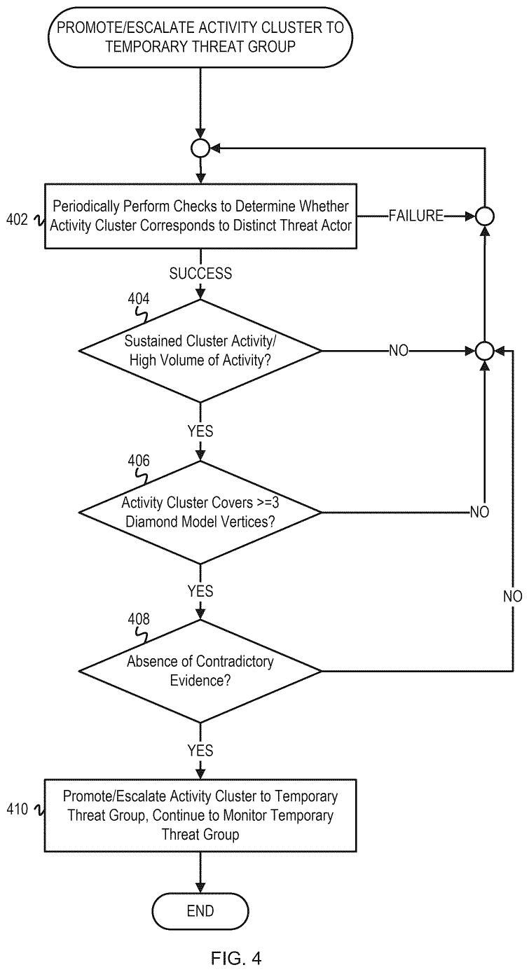

FIG. 4 is a flowchart of example operations for promoting/escalating an activity cluster to a temporary threat group. At block 402, the threat attribution module periodically performs checks to determine whether an activity cluster corresponds to a distinct threat actor. The checks include deep dives into TTPs, infrastructure, and victim profiles, malware and tool analysis, analysis for OPSEC consistence, and correlation with external events within a timeline of the activity cluster. If the check was a failure (i.e., the activity cluster cannot be confirmed to correspond to a distinct threat actor), operational flow continues at block 402 for additional periodic checks as the activity cluster accumulates more activity data. Otherwise (check success), operational flow proceeds to block 404.

At block 404, the threat attribution module determines whether there was sustained cluster activity/high volume activity within a recent time period (e.g., last six months). The recent time period can depend on high availability/scarcity of data for the activity cluster and can be adjusted by a threat analyst. The determination of whether there was a high volume of activity can comprise whether there was a threshold number of incidents (e.g., 4) with moderate or high confidence of being attributed to the activity cluster within the recent time period. If the threat attribution module determines that there was sustained cluster activity/high volume activity within the recent time period, operational flow proceeds to block 406. Otherwise, operational flow returns to block 402.

At block 406, the threat attribution module determines whether the activity cluster covers at least three vertices of the diamond model. The threat attribution module can further determine whether there are consistent TTPs and infrastructure usage over the time period, that custom infrastructure tools/configurations were deployed during the time period, etc. If the threat attribution module determines that the activity cluster covers at least three vertices of the diamond model, operational flow proceeds to block 408. Otherwise, operational flow returns to block 402.

At block 408, the threat attribution module determines whether there is an absence of evidence contradictory to the hypothesis that the activity cluster corresponds to a single threat actor. If there is contradictory evidence, operational flow returns to block 402. Otherwise, if there is an absence of contradictory evidence, operational flow proceeds to block 410.

At block 410, the threat attribution module promotes/escalates an activity cluster to a temporary threat group and continues to monitor the temporary threat group. The threat attribution module can monitor the temporary threat group according to the criteria/checks at blocks 402, 404, 406, and 408 to determine whether the activity cluster still presents as a temporary threat group and can deescalate/demote the temporary threat group to an activity cluster otherwise.

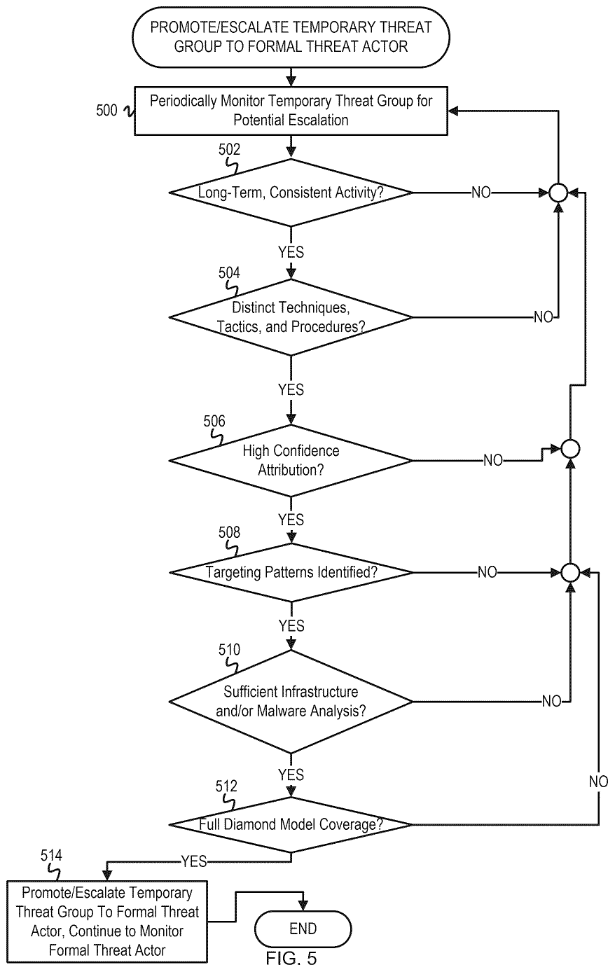

FIG. 5 is a flowchart of example operations for promoting/escalating a temporary threat group to a formal threat actor. Although referred to as a “formal threat actor”, escalation from temporary threat group to formal threat actor occurs for the event/observable data and corresponding natural language documentation maintained in association with actions performed by the formal threat actor. FIG. 5 assumes that an activity cluster has been previously escalated to a temporary threat group.

At block 500, the threat attribution module periodically monitors the temporary threat group for potential escalation. The threat attribution module can periodically retrieve and analyze event/observable data as well as documentation maintained by analysts for the temporary threat group that can track threat aspects such as attack frameworks, overlapping IoCs/TTPs across threat aspects such as the diamond model, etc. Periodic monitoring can occur according to a schedule and/or as cybersecurity incidents related to the temporary threat group occur.

At block 502, the threat attribution module determines whether the temporary threat group has demonstrated long-term, consistent activity over a period of time (e.g., a year). The period of time is longer than the recent time period used for escalating activity clusters to temporary threat groups in FIG. 4. Pre-existing threat groups may be exempt from the determination at block 502 and operational flow would proceed to block 504 for those threat groups. If the threat attribution module determines that there is long-term, consistent activity, operational flow proceeds to block 504. Otherwise, operational flow returns to block 500.

At block 504, the threat attribution module determines whether the temporary threat group corresponds to distinct TTPs over the period of time that are differentiated from TTPs for other known actors. If the threat attribution module determines that the temporary threat group corresponds to distinct TTPs, operational flow proceeds to block 506. Otherwise, operational flow returns to block 500.

At block 506, the threat attribution module determines whether an attribution level had high confidence in the period of time. The attribution level is determined to be high confidence using an attribution table of reliability and credibility scores for corresponding data sources and entity types, respectively, according to an aggregate of the reliability and credibility scores. In addition to requiring that the aggregate score be above a threshold for high confidence, the threat attribution module can additionally determine whether there were a threshold number of reliable sources (e.g., data sources with a reliability score of at least two). The attribution level may or may not correspond to a named or identified formal threat actor. If the attribution level corresponds to a named or identified formal threat actor, then that will be the formal threat actor used as a label during promotion/escalation (provided the remaining criteria in FIG. 5 are satisfied). Otherwise, the formal threat actor will be assigned a placeholder identifier that can be subsequently updated by cybersecurity experts as the identity of the formal threat actor is more well-understood. If the threat attribution module determines that attribution had high confidence, operational flow proceeds to block 508. Otherwise, operational flow returns to block 500.

At block 508, the threat attribution module determines whether targeting patterns for the temporary threat group were identified in the period of time. The targeting patterns include objectives, typical targets, and motives for an actor performing the actions of the temporary threat group. If the threat attribution module determines that targeting patterns were identified, operational flow proceeds to block 510. Otherwise, operational flow returns to block 500.

At block 510, the threat attribution module determines whether there was sufficient infrastructure and/or malware analysis in the period of time. For instance, the threat attribution module can determine whether the temporary threat group activity was linked to particular infrastructure elements, whether there were unique code characteristics, shared codebases, links to other known malware families used by the temporary threat group, etc. If the threat attribution module determines that there was sufficient infrastructure and/or malware analysis, operational flow proceeds to block 512. Otherwise, operational flow returns to block 500.

At block 512, the threat attribution module determines whether there was full diamond model coverage for the temporary threat group over the period of time. If the threat attribution module determines that there was full diamond model coverage, operational flow proceeds to block 514. Otherwise, operational flow returns to block 500.

At block 514, the threat attribution module promotes/escalates the temporary threat group to a formal threat actor and continues to monitor the formal threat actor. Over time, the threat attribution module can determine whether to deescalate/demote the formal threat actor to a temporary threat group, whether to add or merge other activity clusters/temporary threat groups/formal threat actors to the formal threat actor, etc. The threat attribution module can additionally attempt to accurately label the formal threat actor, e.g., as an individual, country, or known group of individuals.

FIG. 6 is a flowchart of example operations for determining attribution confidence with attribution tables. FIG. 6 assumes that events/observables or groups of events/observables (described simply as individual events/observables in the remainder of FIG. 6) have been collected for an activity cluster, temporary threat group, and/or formal threat actor over a period of time and that one or more of the events/observables have been associated with particular entities and/or data sources. A same entity can have distinct sets of events/observables for different data sources, resulting in distinct rows in the attribution table in the subsequent operations.

At block 600, the threat attribution module begins iterating through events/observables associated with entities and a particular data source used for attribution in the period of time.

At block 602, the threat attribution module determines a default suggested score for the event/observable based on a default reliability score for a data source and a credibility score for an entity type of the event/observable. The suggested score is based on the Admiralty scale and comprises a tuple of the default reliability score and the default credibility score, for instance expressed as an alphanumeric tuple.

At block 604, the threat attribution module populates an attribution table with a row indicating (at least) one or more diamond model vertices corresponding to the event/observable, the entity type, the data source, and the default suggested score.

At block 606, the threat attribution module continues iterating through events/observables collected for attribution during the period of time. If there is an additional event/observable, operational flow returns to block 600. Otherwise, operational flow proceeds to block 608.

At block 608, the threat attribution module updates the default suggested scores and computes an aggregate confidence score with the updated suggested scores using estimative language. Updating of default suggested scores can be based on a judgement of a domain-level expert according to language in the above tables regarding reliability and credibility. Each update should be documented alongside a reasoning for the update. The estimative language can comprise the estimative language defined by the MISP project quoted in the foregoing.

### Variations

The foregoing description describes determining whether threshold numbers of categories/perspectives of the diamond model are covered when determining whether to escalate activity cluster to temporary threat groups and temporary threat groups to formal threat actors. In general, any cybersecurity methodology that defines perspectives/categories of malicious activity across events/observables can be used instead of the diamond model. Moreover, other scoring methodologies than the Admiralty scale can be used for scoring data sources, entity types, and/or events/observables.

In practice, the threat attribution module described in the foregoing can be deployed variously on both the frontend and backend—as instruction sets provided to cyber threat analysts via a user interface, as tools for displaying attribution tables, computing aggregate scores, tracking events/observables, etc. Many of the aforementioned criteria for escalation can be automated by the threat attribution module and can later be validated and documented by the cyber threat analysts. The criteria can vary in terms of severity based on level of attribution (activity cluster, temporary threat group, formal threat actor), and can vary from the aforementioned criteria described in the foregoing by omitting, adding, or modifying any of the criteria (e.g., adding a requirement to cover a number of vertices in the diamond model, removing a requirement to cover a number of vertices in the diamond model, modifying the required number of vertices in the diamond model, etc.). In some embodiments more, less, or different levels of attribution can be defined for escalation of activity clusters. For instance, activity clusters may be escalated directly to formal threat actors and increased levels of formal threat actors can be attributed to formal threat actors such as known malicious individuals, industries, countries, or other entities.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

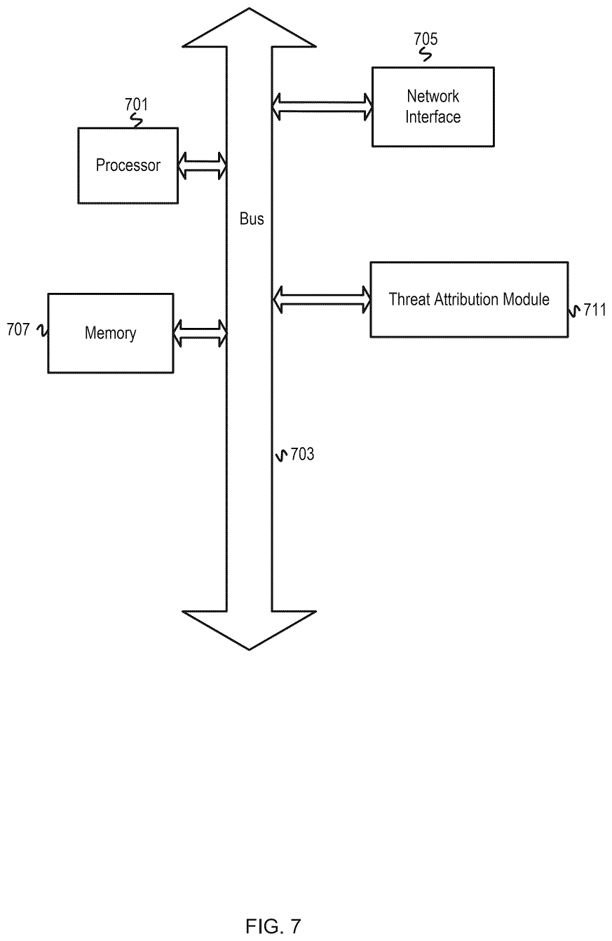

FIG. 7 depicts an example computer system with a threat attribution module. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes a threat attribution module 711. The threat attribution module 711 detects event/observable data that potentially corresponds to activity clusters. The threat attribution module 711 monitors attribution levels of the events/observables (e.g., activity clusters, temporary threat groups, etc.) for escalation/promotion, de-escalation/demotion, merging, splitting, etc. The threat attribution module 711 determines to promote or demote based on analyzing TTPs, IoCs, victims, etc. and by computing aggregate attribution scores and aspects/perspectives that are covered according to cybersecurity models such as the diamond model. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

An “activity cluster” can alternatively be referred to as a “threat cluster” or a “cluster of threat activity”.

1. A method comprising:
detecting an activity cluster that has not been attributed for threat analysis; and
attributing the activity cluster to a threat actor, wherein attributing the activity cluster comprises,
for sources of data of the activity cluster and types of the data, determining first scores for reliability of the sources and second scores for credibility of the types of data, wherein determining the first scores and second scores is based, at least in part, on default scores corresponding to descriptors of sources of the data and types of the data, respectively;
determining an aggregate score for the activity cluster as a weighted combination of the first scores and the second scores; and
determining that one or more criteria for attribution to the threat actor corresponding to the aggregate score, the first scores, and the second scores are satisfied and that the data for the activity cluster corresponds to a threshold number of perspectives of malicious activity.

2. The method of claim 1, wherein the one or more criteria comprise at least one of,
a criterion that the aggregate score exceeds a threshold aggregate score and
a criterion that a number of the first scores and/or the second scores exceeding a threshold score exceeds a threshold number of scores.

3. The method of claim 2, wherein the threshold aggregate score corresponds to a scale of the threat actor.

4. The method of claim 1, wherein attributing the activity cluster to the threat actor comprises merging the activity cluster with an existing activity cluster for the threat actor.

5. The method of claim 1, wherein the perspectives of malicious activity comprise adversaries, infrastructures, capabilities, and victims.

6. The method of claim 1, wherein determining the first scores and the second scores comprises applying estimative language to determine descriptors corresponding to the first scores and the second scores.

7. The method of claim 1, wherein the types of data comprise at least one of Internet Protocol addresses, domain names, uniform resource locators, Transport Layer Security fingerprints, Secure Sockets Layer fingerprints, JARM fingerprint hashes, certificate fields, Secure Shell host keys, registrant information, and registrant timeframes.

8. The method of claim 1, wherein the data of the activity cluster comprises at least one of observed indicators, tactics, techniques, and procedures, signatures, and victim identifiers.

9. The method of claim 1, wherein the descriptors of sources of the data indicate at least one of reliable, usually reliable, fairly reliable, not usually reliable, unreliable, and reliably unknown, and wherein the descriptors of types of the data indicate confirmed, probably true, possibly true, doubtfully true, improbable, and difficult to say.

10. A non-transitory machine-readable medium having program code stored thereon, the program code comprising instructions to:
detect an activity cluster that has not been attributed for threat analysis; and
promote an attribution level of the activity cluster, wherein the instructions to promote the attribution level of the activity cluster comprise instructions to,
for sources of data and entity types for at least one of events and observables in the activity cluster, determine first scores for reliability of the sources and second scores for credibility of the entity types, wherein determining the first scores and second scores is based, at least in part, on default scores corresponding to descriptors of sources of the data and entity types, respectively;
determine an aggregate score for the activity cluster as a weighted combination of the first scores and the second scores; and
determine that one or more criteria for promotion of the attribution level corresponding to the aggregate score, the first scores, and the second scores are satisfied and that the at least one of events and observable in the activity cluster correspond to a threshold number of perspectives of malicious activity.

11. The non-transitory machine-readable medium of claim 10, wherein the one or more criteria comprise at least one of,
a criterion that the aggregate score exceeds a threshold aggregate score; and
a criterion that a number of the first scores and/or the second scores exceeding a threshold score exceeds a threshold number of scores.

12. The non-transitory machine-readable medium of claim 11, wherein the threshold aggregate score corresponds to a scale of the attribution level.

13. The non-transitory machine-readable medium of claim 10, wherein the attribution level comprises at least one of an activity cluster, a temporary threat group, and a formal threat actor.

14. The non-transitory machine-readable medium of claim 10, wherein the perspectives of malicious activity comprise adversaries, infrastructures, capabilities, and victims.

15. The non-transitory machine-readable medium of claim 10, wherein the instructions to determine the first scores and the second scores comprise instructions to apply estimative language to determine descriptors corresponding to the first scores and the second scores.

16. An apparatus comprising:
a processor; and
a machine-readable medium having instructions stored thereon that are executable by the processor to cause the apparatus to,
detect an activity cluster that has not been attributed for threat analysis; and
promote an attribution level of the activity cluster, wherein the instructions to promote the attribution level of the activity cluster comprise instructions to,
for sources of data and entity types for at least one of events and observables in the activity cluster, determine first scores for reliability of the sources and second scores for credibility of the entity types, wherein determining the first scores and second scores is based, at least in part, on default scores corresponding to descriptors of sources of the data and entity types, respectively;
determine an aggregate score for the activity cluster as a weighted combination of the first scores and the second scores; and
determine that one or more criteria for promotion of the attribution level corresponding to the aggregate score, the first scores, and the second scores are satisfied and that the at least one of events and observable in the activity cluster correspond to a threshold number of perspectives of malicious activity.

17. The apparatus of claim 16, wherein the one or more criteria comprise at least one of,
a criterion that the aggregate score exceeds a threshold aggregate score; and
a criterion that a number of the first scores and/or the second scores exceeding a threshold score exceeds a threshold number of scores.

18. The apparatus of claim 17, wherein the threshold aggregate score corresponds to a scale of the attribution level.

19. The apparatus of claim 16, wherein the perspectives of malicious activity comprise adversaries, infrastructures, capabilities, and victims.

20. The apparatus of claim 16, wherein the instructions to determine the first scores and the second scores comprise instructions executable by the processor to cause the apparatus to apply estimative language to determine descriptors corresponding to the first scores and the second scores.
